(19) United States
(12) Patent Application Publication
(10) Pub. No.: US 2023/0281506 A1
(43) Pub. Date: Sep. 7, 2023

(54) LEARNING DEVICE, LEARNING METHOD, AND LEARNING PROGRAM

(71) Applicant: NEC Corporation, Minato-ku, Tokyo (JP)

(72) Inventors: Dai KUBOTA, Tokyo (JP); Riki ETO, Tokyo (JP)

(73) Assignee: NEC Corporation, Minato-ku, Tokyo (JP)

(21) Appl. No.: 17/922,029

(22) PCT Filed: May 11, 2020
(86) PCT No.: PCT/JP2020/018767

§ 371 Date: Oct. 28, 2022

(51) Int. Cl. G06N 20/00

(52) U.S. Cl. CPC G06N 20/00

(57) ABSTRACT

The first output means 81 outputs a second target, which is an optimization result for a first target using an objective function generated in advance by inverse reinforcement learning based on decision making history data indicating an actual change to the target. The second output means 82 outputs a third target indicating a target resulting from further changing of the second target based on a change instruction regarding the second target accepted from the user. The data output means 83 outputs the actual change from the second target to the third target as decision making history data. The learning means 84 learns the objective function using the decision making history data.

### TECHNICAL FIELD

This invention relates to a learning device, a learning method, and a learning program that reflect the user’s intention.

### BACKGROUND ART

Advances in AI (Artificial Intelligence) technology are leading to the automation of tasks that require skilled techniques. AI automation requires the appropriate formulation of the objective function to be used for prediction and optimization. Therefore, various methods have been proposed to simplify the formulation of the objective function.

One method known to simplify the formulation is inverse reinforcement learning. Inverse reinforcement learning is a learning method that estimates an objective function (reward function) for evaluating actions in each state based on the history of decision making made by a skilled person. In inverse reinforcement learning, the reward function of a skilled person is estimated by updating the reward function so that the history of decision making approaches that of the skilled person.

Non-patent literature 1 describes maximum entropy inverse reinforcement learning, which is one type of inverse reinforcement learning. In the method described in Non-patent literature 1, only one reward function R(s, a, s′) = θ•f (s, a, s′) is estimated from the skilled person’s data D = {τ₁, τ₂, ... τ_{N}} (where τᵢ = ((s₁, a₁), (s₂, a₂), ..., (s_{N}, a_{N})), where sᵢ represents the state and aᵢ represents the action.) This estimated θ can be used to reproduce the decision making of a skilled person.

Non-patent literatures 2 and 3 describe learning methods using ranked data.

### CITATION LIST

### Non Patent Literature

NPL 1: B. D. Ziebart, A. Maas, J. A. Bagnell, and A. K. Dey, “Maximum entropy inverse reinforcement learning,” in AAAI, AAAI′08, 2008.
NPL 2: Brown, Daniel S., et al, “Extrapolating beyond suboptimal demonstrations via inverse reinforcement learning from observations,” in Proceedings of the 36th International Conference on Machine Learning, PMLR 97:783-792, 2019.
NPL 3: Castro, Pablo Samuel, Shijian Li, and Daqing Zhang. “Inverse Reinforcement Learning with Multiple Ranked Experts”, arXiv preprint arXiv:1907.13411, 2019.

### SUMMARY OF INVENTION

### Technical Problem

In order to reproduce the decision making of a skilled person, it is preferable to learn the objective function using a large amount of decision making history data. On the other hand, important indicators and optimality in business often change due to trends, social issues, and changes in clientele in that era. In such cases, the objective function learned by inverse reinforcement learning or inverse optimization as described in Non-patent literature 1 may also deviate from the true objective function of the era. Therefore, it is desirable to learn the objective function in each case using timely historical decision making history data that is in line with the times.

However, even if the objective function is relearned, it is not always possible to collect decision making history data, so it is not easy to learn the objective function that appropriately reflects the user’s intentions in accordance with the times. For example, it is difficult to collect data on decisions making that occur infrequently.

Therefore, it is an exemplary object of the present invention to provide a learning device, a learning method, and a learning program that can learn an objective function that reflects the user’s intention.

### Solution to Problem

The learning device according to the present invention including: a first output means which outputs a second target, which is an optimization result for a first target using an objective function generated in advance by inverse reinforcement learning based on decision making history data indicating an actual change to the target; a second output means which outputs a third target indicating a target resulting from further changing of the second target based on a change instruction regarding the second target accepted from the user; a data output means which outputs the actual change from the second target to the third target as decision making history data; and a learning means which learns the objective function using the decision making history data.

The learning method according to the present invention including: outputting a second target, which is an optimization result for a first target using an objective function generated in advance by inverse reinforcement learning based on decision making history data indicating an actual change to the target; outputting a third target indicating a target resulting from further changing of the second target based on a change instruction regarding the second target accepted from the user; outputting the actual change from the second target to the third target as decision making history data; and learning the objective function using the decision making history data.

The learning program according to the present invention causing the computer to execute: first output process of outputting a second target, which is an optimization result for a first target using an objective function generated in advance by inverse reinforcement learning based on decision making history data indicating an actual change to the target; second output process of outputting a third target indicating a target resulting from further changing of the second target based on a change instruction regarding the second target accepted from the user; data output process of outputting the actual change from the second target to the third target as decision making history data; and learning process of learning the objective function using the decision making history data.

### Advantageous Effects of Invention

According to this invention, the objective function can be learned that reflects the user’s intention.

### BRIEF DESCRIPTION OF THE DRAWING

FIG. 1 It depicts a block diagram showing a configuration example of the first exemplary embodiment of the learning device according to the present invention.

FIG. 2 It depicts an explanatory diagram showing an example of the process of changing the target.

FIG. 3 It depicts a flowchart showing an example of the operation of the first exemplary embodiment of the learning device.

FIG. 4 It depicts a block diagram showing a configuration example of the second exemplary embodiment of the learning device according to the present invention.

FIG. 5 It depicts an explanatory diagram showing an example of decision making history data.

FIG. 6 It depicts an explanatory diagram showing an example of the process of accepting selection instructions from the user.

FIG. 7 It depicts a flowchart showing an example of the operation of the second exemplary embodiment of the learning device.

FIG. 8 It depicts a block diagram showing a modified example of the second exemplary embodiment of the learning device.

FIG. 9 It depicts a block diagram showing an overview of a learning device according to the present invention.

### DESCRIPTION OF EMBODIMENTS

The following is a description of the exemplary embodiment of the invention with reference to the drawings.

### Exemplary Embodiment 1

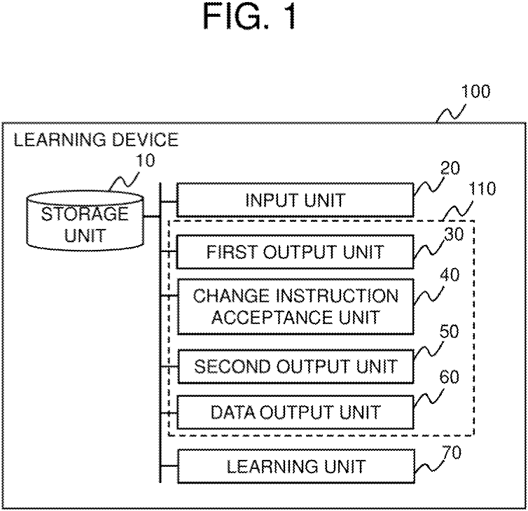

FIG. 1 is a block diagram showing a configuration example of the first exemplary embodiment of the learning device according to the present invention. The learning device of this exemplary embodiment is a learning device that performs inverse reinforcement learning based on decision making history data indicating an actual change to the target (hereinafter simply referred to as “target”) to be changed.

In the following explanation, a diagram of a train or aircraft (hereinafter referred to as an “operation schedule”) is targeted, and the actual change for the operation schedule is exemplified as decision making history data. However, the target assumed in this exemplary embodiment is not limited to the operation schedule, but may also include, for example, ordering information of stores and control information of various devices equipped in vehicles.

The learning device 100 in this exemplary embodiment includes a storage unit 10, an input unit 20, a first output unit 30, a change instruction acceptance unit 40, a second output unit 50, a data output unit 60, and a learning unit 70.

The storage unit 10 stores parameters and various information used by the learning device 100 in this exemplary embodiment for processing. The storage unit 10 of this exemplary embodiment also stores an objective function generated in advance by inverse reinforcement learning based on the decision making history data indicating the actual change of the target. The storage unit 10 may also store the decision making history data itself.

The input unit 20 accepts input for the target (i.e., the target) to be changed. For example, when the target is an operation schedule, the input unit 20 accepts input of the operation schedule to be changed. The input unit 20 may, for example, accept the target stored in the storage unit 10 in response to an instruction by a user or other person.

The first output unit 30 outputs the optimization result (hereinafter referred to as “second target”) using the above objective function for the target to be changed (hereinafter referred to as the “first target”) accepted by the input unit 20. The first output unit 30 may also output the objective function used in the optimization process together.

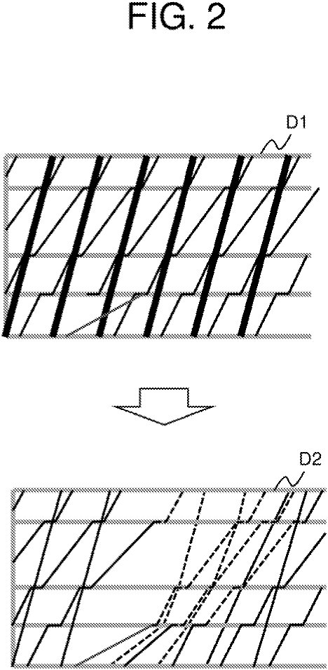

FIG. 2 is an explanatory diagram showing an example of the process of changing the target performed by the first output unit 30.

The target illustrated in FIG. 2 is an operation schedule, FIG. 2 shows that as a result of the optimization processing by the first output unit 30, the operation schedule D1 to be changed has been changed to the operation schedule D2. In the example shown in FIG. 2, the change is indicated by a dotted line.

The change instruction acceptance unit 40 outputs the second target. The change instruction acceptance unit 40 may, for example, display the second target on a display device (not shown). The change instruction acceptance unit 40 then accepts change instructions from the user regarding the output second target. The user giving the change instructions is, for example, a person skilled in the field of the target.

The content of the change instruction is arbitrary, as long as the information is necessary to change the second target. Specific examples of change instructions are described below. Three types of change instruction types are described in this exemplary embodiment. The first type is a direct change instruction to the output second target. For example, if the target is the operation schedule, the change instruction in the first type may be, for example, a change in the operation time or a change in the operation flight.

The second type is a change instruction for the objective function used to change the first target. Assuming that the objective function is represented by a linear expression, the change instruction according to the second type is an instruction to change the weights of the explanatory variables included in the objective function. When the objective variable is expressed in a linear expression, the weight of each explanatory variable indicates the degree of importance given to that explanatory variable. Therefore, the instruction to change the weight of the explanatory variable included in the objective variable can be said to be an instruction to modify the viewpoint from which the target is changed.

The change instruction acceptance unit 40 may accept a designation of the value of the explanatory variable to be changed, or may accept a designation of the degree of change (e.g., magnification, etc.) relative to the current explanatory variable.

The third type is also a change instruction to the objective function used to change the first target. The change instruction according to the third type is an instruction to add an explanatory variable to the objective function. The addition of an explanatory variable can be said to be an instruction to add a feature that was not initially assumed as a factor to be considered. The selection, creation, etc. of the feature (explanatory variable) is performed by the user (operator) in advance.

The following describes the specific method of reflecting the new feature (explanatory variable) into the objective function. In this exemplary embodiment, the feature vector before the change is φ₀(x). Here, x represents the state of the target when optimization is performed, and each feature can be regarded as an optimal indicator that changes with the state x. It is also assumed that the objective function used for optimization is expressed in the form J₀(x) = θ₀•φ₀(x).

Also, let φ₁(x) be the newly added feature vector. Here, it is defined that φ(x) ≡ (φ₀(x), φ₁(x)) and θ ≡ (θ₀, θ₁). The new objective function is then defined as J = θ•φ(x).

The second output unit 50 outputs the target (hereinafter referred to as “third target”) resulting from further changing the second target based on the change instruction regarding the second target accepted from the user. In other words, the second output unit 50 outputs the result in accordance with the accepted change instruction.

For example, it is assumed that a change instruction according to the above first type (i.e., a direct change instruction to the second target) is accepted from the user. In this case, the second output unit 50 outputs the resulting target itself based on the accepted change instruction as the third target.

Also, it is assumed that a change instruction according to the above second type (i.e., a change instruction for the weights of explanatory variables included in the objective function represented by a linear expression) is accepted from the user. In this case, the second output unit 50 outputs a third target as a result of changing the second target by optimization using the changed objective function.

Furthermore, it is assumed that a change instruction according to the above third type (i.e., a change instruction to add a new explanatory variable to the objective function) is accepted from the user. In this case, the second output unit 50 outputs the third target as a result of changing the second target by optimization using the changed objective function.

The data output unit 60 outputs the actual change from the second target to the third target as decision making history data. Specifically, the data output unit 60 may output the decision making history data in a manner that can be used for learning the objective function. For example, the data output unit 60 may store the decision making history data in the storage unit 10. In the following description, the data output by the data output unit 60 may be referred to as data for relearning.

The learning unit 70 learns the objective function using the output decision making history data. Specifically, the learning unit 70 relearns the objective function used to change the first target using the output decision making history data.

Since the types of explanatory variables (features) included in the objective variable itself are not changed in the change instructions according to the first type and second type, the learning unit 70 may relearn in the same way as it did for the existing objective function.

On the other hand, in the case of a change instruction according to the third type, the learning unit 70 relearns the objective function including the added explanatory variables. For example, the objective function before the change (i.e., the objective function before adding the new features) is assumed to be close to the true objective function, since the operation was once performed using that objective function.

Therefore, the learning unit 70 may initially estimate θ as θ = (θ₀, 0) (i.e., θ₁ = 0) for relearning in the specific example above, and relearn based on the inverse reinforcement learning algorithm. Since the initial estimation is close to the true θ, estimating in this way can reduce the computation time. However, the method of initial estimation is not limited to the above methods.

The input unit 20, the first output unit 30, the change instruction acceptance unit 40, the second output unit 50, the data output unit 60, and the learning unit 70 are realized by a processor (for example, CPU (Central Processing Unit), GPU (Graphics Processing Unit)) of a computer that operates according to a program (a learning program).

In this case, for example, a program may be stored in the storage unit 10, and the processor may read the program and operate as the input unit 20, the first output unit 30, the change instruction acceptance unit 40, the second output unit 50, the data output unit 60, and the learning unit 70 according to the program. In addition, the functions of the input unit 20, the first output unit 30, the change instruction acceptance unit 40, the second output unit 50, the data output unit 60, and the learning unit 70 may be provided in the form of SaaS (Software as a Service).

The input unit 20, the first output unit 30, the change instruction acceptance unit 40, the second output unit 50, the data output unit 60, and the learning unit 70 may each be realized by dedicated hardware. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the input unit 20, the first output unit 30, the change instruction acceptance unit 40, the second output unit 50, the data output unit 60, and the learning unit 70 are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

The first output unit 30 outputs the target to be changed, the change instruction acceptance unit 40 accepts the change instruction for the output target, the second output unit 50 outputs the changed target based on the change instruction, and the data output unit 60 outputs the actual change as decision making history data, thereby generating new decision making history data (data for relearning). Therefore, a device 110 including the first output unit 30, the change instruction acceptance unit 40, the second output unit 50, and the data output unit 60 can be said to be a data generating device.

In this case, the first output unit 30, the change instruction acceptance unit 40, the second output unit 50, and the data output unit 60 may be realized by a computer processor operating according to a program (data generation program).

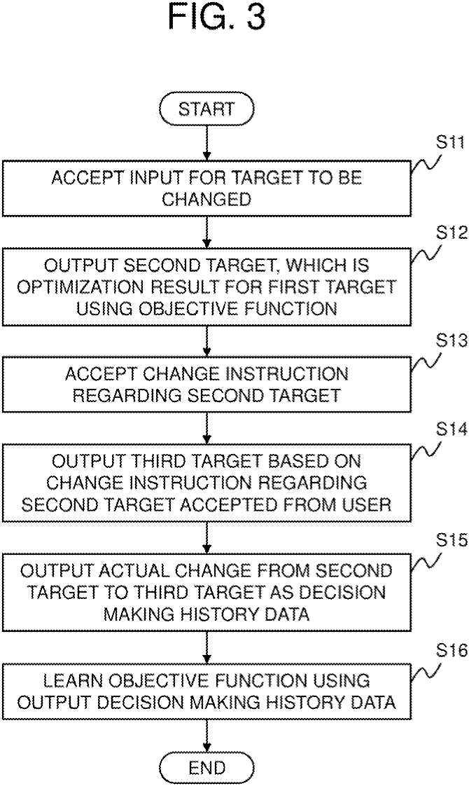

Next, the operation example of this exemplary embodiment of the learning device 100 will be described. FIG. 3 is a flowchart showing an example of the operation of the first exemplary embodiment of the learning device 100. The input unit 20 accepts input for a target to be changed (step S11). The first output unit 30 outputs a second target, which is an optimization result for a first target using an objective function (step S12). The change instruction acceptance unit 40 accepts a change instruction regarding the second target (Step S13). The second output unit 50 outputs a third target based on a change instruction regarding the second target accepted from the user (Step S14). The data output unit 60 outputs an actual change from the second target to the third target as decision making history data (step S15). The learning unit 70 learns the objective function using the output decision making history data (step S16).

As described above, in this exemplary embodiment, the first output unit 30 outputs a second target, which is the optimization result for a first target using an objective function, and the second output unit 50 outputs a third target based on a change instruction regarding the second target accepted from the user. The data output unit 60 outputs the actual change from the second target to the third target as decision making history data, and the learning unit 70 learns the objective function using the output decision making history data. Thus, an objective function that reflects the user’s intention can be learned.

### Exemplary Embodiment 2

Next, a second exemplary embodiment of the learning device will be described. The learning device of the second exemplary embodiment is also a learning device that performs inverse reinforcement learning based on decision making history data indicating the actual change of the target to be changed.

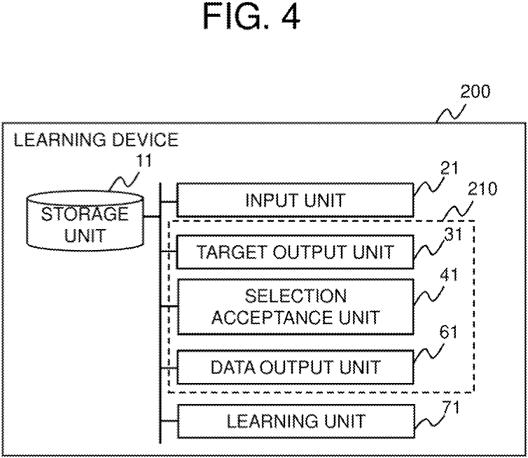

FIG. 4 is a block diagram showing a configuration example of the second exemplary embodiment of the learning device according to the present invention. The learning device 200 in this exemplary embodiment includes a storage unit 11, an input unit 21, a target output unit 31, a selection acceptance unit 41, a data output unit 61, and a learning unit 71.

The storage unit 11 stores parameters and various information used by the learning device 200 in this exemplary embodiment for processing. The storage unit 11 of this exemplary embodiment also stores a plurality of objective functions generated in advance by inverse reinforcement learning based on decision making history data indicating the actual change of the target. The storage unit 11 may also store the decision making history data itself.

The input unit 21 accepts input of the target to be changed (i.e., the first target). As in the first exemplary embodiment, for example, when the target is an operation schedule, the input unit 21 accepts input of the operation schedule to be changed. The input unit 21 may, for example, accept the target stored in the storage unit 11 in response to an instruction by a user or other person.

The input unit 21 may also accept decision making history data from the storage unit 11 and input the data to the target output unit 31. If the decision making history data is stored in an external device (not shown), the input unit 21 may acquire the decision making history data from the external device via a communication line.

The target output unit 31 outputs a plurality of optimization results (second targets) for the first target using one or more objective functions stored in the storage unit 11. In other words, the target output unit 31 outputs a plurality of second targets indicating the targets resulting from changing of the first target by optimization using one or more objective functions.

The method by which target output unit 31 selects the objective function to be used for optimization is arbitrary. However, it is preferable that the target output unit 31 preferentially selects the objective function that better reflects the user’s intention as indicated by the decision making history data.

Let φ(x) be a feature (i.e., an optimization index) that constitutes the objective function, and let x be a state or one candidate solution. Then, when the target of estimation in inverse reinforcement learning is θ, the objective function J can be expressed as J(θ, x) = f(θ, φ(x)). Then, the target output unit 31 uses the previously accumulated decision making history data D (i.e., the input decision making history data) to calculate the likelihood L(D | θ). This likelihood can be said to be a value indicating plausibility (probability) of the decision making history data D when the estimation target is θ.

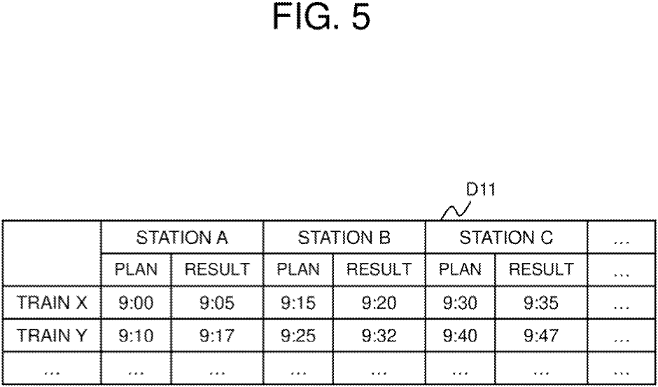

For example, the feature vector is denoted by φ_{y} (x) when the modified schedule is denoted by x and the pair of constant parameter values of the operation schedule is denoted by y. The decision making history data D can be expressed as D = {(x₁, y₁), (x₂, y₂), ...}. FIG. 5 is an explanatory diagram showing an example of decision making history data. The decision making history data illustrated in FIG. 5 is an example of historical data of train operation schedules, which corresponds to plans and results at each station of each train.

Here, in the framework of maximum entropy inverse reinforcement learning, the target output unit 31 may calculate the likelihood L(D |θ) based on Equation 1, which is illustrated below. In Equation 1, |D| is the number of decision making history data, and X_{y} is the space that can be taken by a feasible modified schedule x under a fixed time schedule y. [Math. 1]

$$\text{L} \left(\text{D} \left|θ\right)\right) = {\prod }_{k = 1}^{\left|D\right|} \frac{{e}^{{J}_{y} {}_{{}_{k}}} {}^{( θ , {x}_{k} )}}{\sum {}_{{x}_{k} ∈ {X}_{y}} {e}^{{J}_{{y}_{k}} \left(θ , {x}_{k}\right)}} \qquad \text{(Equation 1)}$$

The form of the objective function used in this exemplary embodiment is arbitrary. The objective function may be represented by a linear expression with respect to θ, such as f(θ, φ(x)) = θ•φ(x), or may be represented by a deep neural network where the input is φ(x) and the output is the objective function value. When the objective function is represented by a deep neural network, θ corresponds to the hyperparameters of the neural network. In either case, θ is a value that reflects the user’s intention as indicated by the decision making history data.

Therefore, the target output unit 31 may select a predetermined number (e.g., two) of objective functions for which the likelihood L(D|θ) described above is larger, and output the second target changed from the first target by optimization using the selected objective functions. However, the number of selected objective functions is not limited to two, but may be three or more.

In order to ensure that the second target to be output is not similar (i.e., that there is variety), the target output unit 31 may randomly select the objective function and output a second target. Furthermore, since θ to be estimated by inverse reinforcement learning is the value that maximizes the likelihood L(D | θ), the target output unit 31 may select the top N θs (i.e., objective functions) with high likelihood D among the θs for which ∂L(D | θ) / ∂θ = 0 (maximum condition: θ derivative is 0).

It is assumed, for example, that the objective function that was estimated before relearning can be assumed to be close to the true objective function at the time of relearning. In this case, the target output unit 31 may calculate the likelihood using the decision making history data Dₚᵣₑᵥ used during the initial learning, or the decision making history data Dₐ obtained by adding data for relearning to the Dₚᵣₑᵥ. The data for relearning added here may include data output by the data output unit 61 described below, as well as decision making history data such as that output by the data output unit 60 in the first exemplary embodiment. Then, the target output unit 31 may exclude objective functions whose calculated likelihood values are lower than a certain threshold from the selection targets. In this way, the cost of searching for misplaced θ due to a small amount of data for relearning can be reduced, thus enabling efficient relearning.

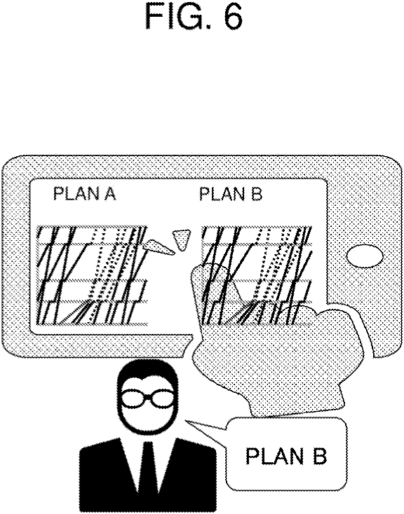

The selection acceptance unit 41 accepts a selection instruction from a user for a plurality of the output second targets. The user giving selection instructions is, for example, a person skilled in the field of the target. For example, if the target is an operation schedule, the selection acceptance unit 41 accepts the selection instruction from the user from among the plurality of changed operation schedules. FIG. 6 is an explanatory diagram showing an example of the process of accepting selection instructions from the user. The example shown in FIG. 6 indicates that the selection acceptance unit 41 accepts a selection instruction for Plan B from the user after the target output unit 31 outputs the changed operation schedule Plan A and operation schedule Plan B using different objective functions.

The data output unit 61 outputs the actual change from the first target before the change to the second target accepted by the selection acceptance unit 41 as decision making history data. Specifically, as in the first exemplary embodiment, the data output unit 61 may output decision making history data in a manner that can be used for learning the objective function. For example, the data output unit 61 may store the decision making history data in the storage unit 11. As in the first exemplary embodiment, the data output by the data output unit 61 may be referred to as data for relearning.

The learning unit 71 learns (relearns) one or more objective functions that are candidates using the output decision making history data. The learning unit 71 may select a solution with a higher likelihood than a predetermined threshold among the optimal solutions (optimization results) under each of the candidate objective functions, and relearn by adding decision making history data including the selected solution. The learning unit 71 may relearn for some of the objective functions or all of the objective functions. For example, when relearning for some objective functions, the learning unit 71 may relearn only those objective functions that satisfy a predetermined criterion (e.g., the likelihood exceeds a threshold value θ). After enough data for relearning has been accumulated, the learning unit 71 may learn the objective function in the same way as in ordinary inverse reinforcement learning.

In the initial stage, all the data output by the target output unit 31 (i.e., data presented to the user) may be data output using an objective function that deviates from the true objective function. However, more favorable data (the best data) are selected by the user, and data for relearning are added. Therefore, the estimation accuracy will gradually improve, and the data generated by the objective function that is closer to the true objective function will be selected at the next timing. By repeating this process, the proportion of data generated by the objective functions that are closer to the true objective function will increase, and eventually, the generated data for relearning will enable highly accurate intention learning.

It can be said that the data selected by the skilled person from among the plurality of data is the data generated by the objective function that is closer to the true objective function than the other data. Therefore, the learning unit 71 may learn the objective function using the data ranked in order of closeness to the data generated from the true objective function. In this case, the learning unit 71 may use, for example, the method described in Non-Patent literature 2 or the method described in Non-Patent literature 3 as a learning method using ranked data.

The input unit 21, the target output unit 31, the selection acceptance unit 41, the data output unit 61 and the learning unit 71 are realized by a processor of a computer that operates according to a program (a learning program). As in the first exemplary embodiment, for example, a program may be stored in the storage unit 11, and the processor may read the program and operate as input unit 21, the target output unit 31, the selection acceptance unit 41, the data output unit 61 and the learning unit 71 according to the program.

In addition, the target output unit 31 outputs the target to be changed, the selection acceptance unit 41 accepts a selection instruction for the output target, and the data output unit 61 outputs the changed results as decision making history data, and new decision making history data (data for relearning) is generated. Therefore, the device 210 including the target output unit 31, the selection acceptance unit 41, and the data output unit 61 can be said to be a data generating device.

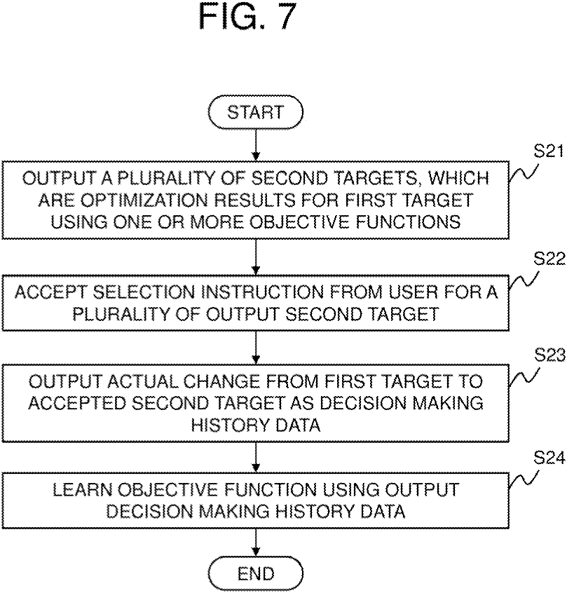

Next, the operation example of this exemplary embodiment of the learning device 200 will be described. FIG. 7 is a flowchart showing an example of the operation of the second exemplary embodiment of the learning device 200. The target output unit 31 outputs a plurality of second targets, which are optimization results for a first target using one or more objective functions (step S21). The selection acceptance unit 41 accepts a selection instruction from a user for a plurality of the output second targets (step S22). The data output unit 61 outputs the actual change from the first target to the accepted second target as the decision making history data (step S23). Then, the learning unit 71 learns the objective function using the output decision making history data (Step S24).

As described above, in this exemplary embodiment, the target output unit 31 outputs a plurality of second targets, which are optimization results of a first target using one or more objective functions, and the selection acceptance unit 41 accepts a selection instruction from a user for a plurality of the output second targets. The data output unit 61 outputs the actual change from the first target to the accepted second target as decision making history data, and the learning unit 71 learns the objective function using the output decision making history data. By such a configuration, an objective function that reflects the user’s intention can be learned.

Next, a modified example of the learning device of this exemplary embodiment will be described. In the second exemplary embodiment, a case has been described in which the actual results to the selected second target are output as decision making history data. In this modified example, a method of accepting a change instruction regarding the selected second target from the user and generating data for relearning will be described.

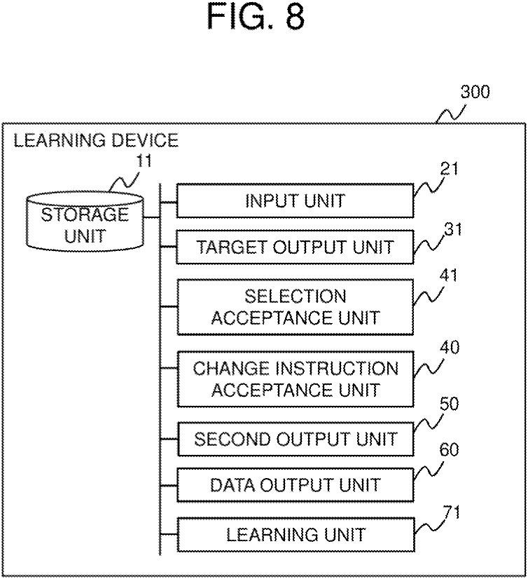

FIG. 8 is a block diagram showing a modified example of the second exemplary embodiment of the learning device. The learning device 300 in this modified example includes a storage unit 11, an input unit 21, a target output unit 31, a selection acceptance unit 41, a change instruction acceptance unit 40, a second output unit 50, a data output unit 60, and a learning unit 71. In other words, the learning device 300 of this modified example differs from the learning device 200 of the second exemplary embodiment in that the learning device 300 includes the change instruction acceptance unit 40, the second output unit 50, and the data output unit 60 of the first exemplary embodiment instead of a data output unit 61.

The change instruction acceptance unit 40 accepts a change instruction from the user regarding the selected second target. The contents of the change instruction are the same as in the first exemplary embodiment. Then, as in the first exemplary embodiment, the second output unit 50 outputs a third target based on the change instruction accepted from the user regarding the second target, and the data output unit 60 outputs an actual change from the second target to the third target as decision making history data.

As described above, in addition to the configuration of the second exemplary embodiment, in this modified example, the second output unit 50 outputs the third target based on a change instruction regarding the second target accepted by the change instruction acceptance unit 40 from the user. The data output unit 60 then outputs the actual change from the second target to the third target as decision making history data. Such a configuration also allows learning an objective function that reflects the user’s intention.

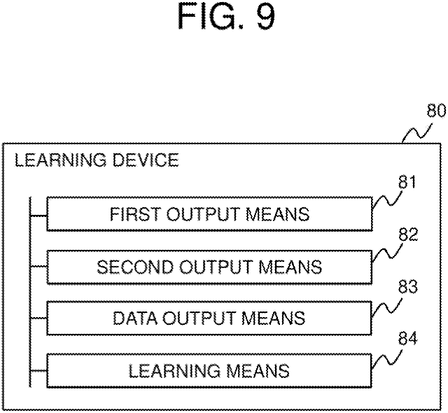

Next, an overview of the present invention will be described. FIG. 9 is a block diagram showing an overview of a learning device according to the present invention. The learning device 80 (e.g., learning device 100) according to the present invention includes a first output means 81 (e.g., first output unit 30) which outputs a second target, which is an optimization result for a first target using an objective function generated in advance by inverse reinforcement learning based on decision making history data indicating an actual change to the target, a second output means 82 (e.g., second output unit 50) which outputs a third target indicating a target resulting from further changing of the second target based on a change instruction regarding the second target accepted from the user, a data output means 83 (e.g., data output unit 60) which outputs the actual change from the second target to the third target as decision making history data, and a learning means 84 (e.g., learning unit 70) which learns the objective function using the decision making history data.

Such a configuration allows learning an objective function that reflects the user’s intentions.

The second output means 82 may accept the direct change instruction (e.g., change instruction according to the first type) from the user for the output second target, and output the resulting target based on the accepted change instruction as the third target.

Other than that, the second output means 82 may accept the change instruction (e.g., change instruction according to the second type) from the user for the weights of explanatory variables included in the objective function represented by a linear expression, and outputs a third target as a result of changing the second target by optimization using the changed objective function.

Other than that, the second output means 82 may accept the change instruction (e.g., change instruction according to the third type) from the user to add an explanatory variable to the objective function, and outputs a third target as a result of changing the second target by optimization using the changed objective function.

Then, the learning means 84 may learn the objective function including the added explanatory variable.

Although some or all of the above exemplary embodiments may also be described as in the following Supplementary notes, the present invention is not limited to the following.

(Supplementary note 1) A learning device comprising: a first output means which outputs a second target, which is an optimization result for a first target using an objective function generated in advance by inverse reinforcement learning based on decision making history data indicating an actual change to the target; a second output means which outputs a third target indicating a target resulting from further changing of the second target based on a change instruction regarding the second target accepted from the user; a data output means which outputs the actual change from the second target to the third target as decision making history data; and a learning means which learns the objective function using the decision making history data.

(Supplementary note 2) The learning device according to Supplementary note 1, wherein the second output means accepts the direct change instruction from the user for the output second target, and outputs the resulting target based on the accepted change instruction as the third target.

(Supplementary note 3) The learning device according to Supplementary note 1, wherein the second output means accepts the change instruction from the user for the weights of explanatory variables included in the objective function represented by a linear expression, and outputs a third target as a result of changing the second target by optimization using the changed objective function.

(Supplementary note 4) The learning device according to Supplementary note 1, wherein the second output means accepts the change instruction from the user to add an explanatory variable to the objective function, and outputs a third target as a result of changing the second target by optimization using the changed objective function.

(Supplementary note 5) The learning device according to Supplementary note 4, wherein the learning means learns the objective function including the added explanatory variable.

(Supplementary note 6) A learning method comprising: outputting a second target, which is an optimization result for a first target using an objective function generated in advance by inverse reinforcement learning based on decision making history data indicating an actual change to the target; outputting a third target indicating a target resulting from further changing of the second target based on a change instruction regarding the second target accepted from the user; outputting the actual change from the second target to the third target as decision making history data; and learning the objective function using the decision making history data.

(Supplementary note 7) A learning method according to Supplementary note 6 further comprising accepting the direct change instruction from the user for the output second target, and outputting the resulting target based on the accepted change instruction as the third target.

(Supplementary note 8) A learning method according to Supplementary note 6 further comprising accepting the change instruction from the user for the weights of explanatory variables included in the objective function represented by a linear expression, and outputting a third target as a result of changing the second target by optimization using the changed objective function.

(Supplementary note 9) A learning method according to Supplementary note 6 further comprising accepting the change instruction from the user to add an explanatory variable to the objective function, and outputting a third target as a result of changing the second target by optimization using the changed objective function.

(Supplementary note 10) A program recording medium in which a learning program is recorded, the learning program causing a computer to execute: first output process of outputting a second target, which is an optimization result for a first target using an objective function generated in advance by inverse reinforcement learning based on decision making history data indicating an actual change to the target; second output process of outputting a third target indicating a target resulting from further changing of the second target based on a change instruction regarding the second target accepted from the user; data output process of outputting the actual change from the second target to the third target as decision making history data; and learning process of learning the objective function using the decision making history data.

(Supplementary note 11) The program recording medium in which the learning program is recorded according to Supplementary note 10, wherein the direct change instruction from the user for the output second target is accepted, and the resulting target based on the accepted change instruction is output as the third target, in the second output process.

(Supplementary note 12) The program recording medium in which the learning program is recorded according to Supplementary note 10, wherein the change instruction from the user for the weights of explanatory variables included in the objective function represented by a linear expression is accepted, and a third target as a result of changing the second target is output by optimization using the changed objective function, in the second output process.

(Supplementary note 13) The program recording medium in which the learning program is recorded according to Supplementary note 10, wherein the change instruction from the user to add an explanatory variable to the objective function is accepted, and a third target as a result of changing the second target is output by optimization using the changed objective function, in the second output process.

(Supplementary note 14) A learning program causing a computer to execute: first output process of outputting a second target, which is an optimization result for a first target using an objective function generated in advance by inverse reinforcement learning based on decision making history data indicating an actual change to the target; second output process of outputting a third target indicating a target resulting from further changing of the second target based on a change instruction regarding the second target accepted from the user; data output process of outputting the actual change from the second target to the third target as decision making history data; and learning process of learning the objective function using the decision making history data.

(Supplementary note 15) The learning program according to Supplementary note 14, wherein the direct change instruction from the user for the output second target is accepted, and the resulting target based on the accepted change instruction is output as the third target, in the second output process.

(Supplementary note 16) The learning program according to Supplementary note 14, wherein the change instruction from the user for the weights of explanatory variables included in the objective function represented by a linear expression is accepted, and a third target as a result of changing the second target is output by optimization using the changed objective function, in the second output process.

(Supplementary note 17) The learning program according to Supplementary note 14, wherein the change instruction from the user to add an explanatory variable to the objective function is accepted, and a third target as a result of changing the second target is output by optimization using the changed objective function, in the second output process.

Although the present invention has been described with reference to the exemplary embodiments and examples, the present invention is not limited to the foregoing exemplary embodiments and examples. Various changes understandable by those skilled in the art can be made to the structures and details of the present invention within the scope of the present invention.

### REFERENCE SIGNS LIST

10, 11 Storage unit
20, 21 Input unit
30 First output unit
31 Target output unit
40 Change instruction acceptance unit
41 Selection acceptance unit
50 Second output unit
60, 61 Data output unit
70, 71 Learning unit
100, 200, 300 Learning device

What is claimed is:

1. A learning device comprising:
a memory storing instructions; and
one or more processors configured to execute the instructions to:
output a second target, which is an optimization result for a first target using an objective function generated in advance by inverse reinforcement learning based on decision making history data indicating an actual change to the target;
output a third target indicating a target resulting from further changing of the second target based on a change instruction regarding the second target accepted from the user;
output the actual change from the second target to the third target as decision making history data; and
learn the objective function using the decision making history data.

2. The learning device according to claim 1, wherein the processor is configured to execute the instructions to
accept the direct change instruction from the user for the output second target, and output the resulting target based on the accepted change instruction as the third target.

3. The learning device according to claim 1, wherein the processor is configured to execute the instructions to
accept the change instruction from the user for the weights of explanatory variables included in the objective function represented by a linear expression, and output a third target as a result of changing the second target by optimization using the changed objective function.

4. The learning device according to claim 1, wherein the processor is configured to execute the instructions to
accept the change instruction from the user to add an explanatory variable to the objective function, and output a third target as a result of changing the second target by optimization using the changed objective function.

5. The learning device according to claim 4, wherein the processor is configured to execute the instructions to
learn the objective function including the added explanatory variable.

6. A learning method comprising:
outputting a second target, which is an optimization result for a first target using an objective function generated in advance by inverse reinforcement learning based on decision making history data indicating an actual change to the target;
outputting a third target indicating a target resulting from further changing of the second target based on a change instruction regarding the second target accepted from the user;
outputting the actual change from the second target to the third target as decision making history data; and
learning the objective function using the decision making history data.

7. A learning method according to claim 6 further comprising
accepting the direct change instruction from the user for the output second target, and outputting the resulting target based on the accepted change instruction as the third target.

8. A learning method according to claim 6 further comprising
accepting the change instruction from the user for the weights of explanatory variables included in the objective function represented by a linear expression, and outputting a third target as a result of changing the second target by optimization using the changed objective function.

9. A learning method according to claim 6 further comprising
accepting the change instruction from the user to add an explanatory variable to the objective function, and outputting a third target as a result of changing the second target by optimization using the changed objective function.

10. A non-transitory computer readable information recording medium storing a learning program, when executed by a processor, that performs a method for:
outputting a second target, which is an optimization result for a first target using an objective function generated in advance by inverse reinforcement learning based on decision making history data indicating an actual change to the target;
outputting a third target indicating a target resulting from further changing of the second target based on a change instruction regarding the second target accepted from the user;
outputting the actual change from the second target to the third target as decision making history data; and
learning the objective function using the decision making history data.

11. The non-transitory computer readable information recording medium according to claim 10, wherein
the direct change instruction from the user for the output second target is accepted, and the resulting target based on the accepted change instruction is output as the third target.

12. The non-transitory computer readable information recording medium according to claim 10, wherein
the change instruction from the user for the weights of explanatory variables included in the objective function represented by a linear expression is accepted, and a third target as a result of changing the second target is output by optimization using the changed objective function.

13. The non-transitory computer readable information recording medium according to claim 10, wherein
the change instruction from the user to add an explanatory variable to the objective function is accepted, and a third target as a result of changing the second target is output by optimization using the changed objective function.
